(19) United States
(12) Patent Application Publication
(10) Pub. No.: US 2018/0198273 A1
(43) Pub. Date: Jul. 12, 2018

(54) NEAR FIELD COMMUNICATION MODULE PROTECTION APPARATUS USING MAGNETIC FIELD, AND PORTABLE TERMINAL THEREOF

(71) Applicant: MAPS, INC., Yongin-si (KR)

(72) Inventors: Jong Tae HWANG, Seoul (KR); Ki-Woong JIN, Anyang-si (KR); Hyun Ick SHIN, Seoul (KR); Joon RHEE, Seoul (KR)

(73) Assignee: MAPS, INC., Yongin-si (KR)

(21) Appl. No.: 15/740,166

(22) PCT Filed: Apr. 21, 2016
(86) PCT No.: PCT/KR2016/004161

§ 371 Date: Dec. 27, 2017

(30) Foreign Application Priority Data
Jun. 29, 2015 (KR) 10-2015-0092438
Jul. 30, 2015 (KR) 10-2015-0108290

(51) Int. Cl. H02H 7/20; H02H 9/04; H02J 7/02; H02J 50/10; H04W 52/04; H04B 5/00

(52) U.S. Cl. CPC H02H 7/20; H02H 9/04; H04B 5/0037; H02J 50/10; H04W 52/04; H02J 7/025

(57) ABSTRACT

Disclosed are a near field communication module protection apparatus using a magnetic field, and a portable terminal thereof. The near field communication module protection apparatus according to one embodiment of the present invention comprises: a determination unit for determining whether a power receiving unit is in a state of receiving a power signal from a power transmitting unit so as to perform wireless charging; and a protection unit for protecting a near field communication module by blocking the transmission of the power signal to the near field communication module when the state in which the power signal is received is determined by the determination unit.

### TECHNICAL FIELD

The present invention relates to a technology of wireless charging and a near field communication module protection apparatus, and more particularly, to a technology for protecting a short range communication module for wireless charging.

### BACKGROUND ART

A short range communication module configured to communicate by forming a magnetic field in a frequency band of several to several tens of MHz has been used in a radio frequency identification (hereinafter, referred to as an RFID) module, a short range communication (hereinafter, referred to as a near field communication (NFC)) module, and the like. In particular, as various applications using an NFC scheme are used on portable terminals, such as mobile phones, the portable terminals are drawing attention as a supplementary payment device.

With regards to inductive wireless charging, a Qi scheme of Wireless Power Consortium (WPC) or a Power Matters Alliance (PMA) scheme performs wireless charging using a low frequency band of 100 kHz. Meanwhile, NFC performs a communication using a 13.56 MHz Industry-Science-Medical band (hereinafter, referred to as an ISM band), which is very different from that of the frequency band for wireless charging, and thus there is little interference therebetween.

In contrast, Alliance for Wireless Power (hereinafter, referred to as A4WP) using magnetic resonance uses a 6.78 MHz ISM band, which is very close to the 13.56 MHz ISM band of NFC, and thus power supplied from an A4WP power transmitting unit (hereinafter, referred to as a PTU) may be unintentionally supplied to an NFC module through an NFC antenna. Generally, an NFC module transmits and receives little power, and when a great amount of power is supplied thereto from the A4WP PTU, the NFC module may receive excessive power, and thus the NFC module may be broken.

### DISCLOSURE

### Technical Problem

The present invention is directed to providing a near field communication module protection apparatus using a magnetic field for wireless charging, and a portable terminal thereof.

### Technical Solution

One aspect of the present invention provides a near field communication protection apparatus, the apparatus including: a determination unit configured to determine whether a power receiving unit is in a state of receiving a power signal from a power transmitting unit for wireless charging; and a protection unit configured to protect a short range communication module by blocking a power signal transmitted to the short range communication module when the determination unit determines that the power receiving unit is in the state of receiving a power signal.

The power transmitting unit and the power receiving unit may transmit and receive a wireless power signal in a first frequency band through magnetic resonance, and the short range communication module may perform a wireless communication using a magnetic field in a second frequency band, and is affected by a magnetic field generated by magnetic resonance between the power transmitting unit and the power receiving unit. The power transmitting unit and the power receiving unit may transmit and receive a wireless power signal by using an Alliance for Wireless Power (A4WP) scheme. The short range communication module may be a near field communication (NFC) module or a radio frequency identification (RFID) module. The first frequency band for wireless charging may be 6.78 MHz, and the second frequency band for the short range communication module may be 13.56 MHz.

The determination unit according to an embodiment may include a rectifier voltage detector configured to detect a rectifier output voltage of the power receiving unit, determine that the power receiving unit is in the state of receiving a power signal when the detected rectifier output voltage is a voltage having a magnitude at which the power receiving unit is operable, and send the protection unit a high-level driving voltage to control the protection unit.

The determination unit according to another embodiment may include a frequency detector configured to detect a resonance frequency from a rectifier input signal of the power receiving unit, determine that the power receiving unit is in the state of receiving a power signal when the detected resonance frequency is a resonance frequency for wireless charging, and send the protection unit a high-level driving voltage to control the protection unit.

The determination unit according to still another embodiment may include: a rectifier voltage detector configured to detect a rectifier output voltage of the power receiving unit, determine that the power receiving unit is in the state of receiving a power signal when the detected rectifier output voltage is a voltage having a magnitude at which the power receiving unit is operable, and output a high-level control signal; a frequency detector configured to detect a resonance frequency from a rectifier input signal of the power receiving unit, determine that the power receiving unit is in the state of receiving a power signal when the detected resonance frequency is a resonance frequency for wireless charging, and output a high-level control signal; and an AND circuit configured to receive the control signal of the rectifier voltage detector and the control signal of the frequency detector, perform a logic product on the received control signals, and send the protection unit a driving voltage for controlling the protection unit.

The protection unit may allow a resonance frequency of a short range communication resonance circuit to be shifted to reduce an amount of power signals transmitted from the power transmitting unit to a short range communication antenna, and block a power signal transmitted from the short range communication antenna to the short range communication module.

The protection unit according to an embodiment may include: a first transistor in which a source is connected to a ground voltage, a drain is connected to a first capacitor, and a gate receives a driving voltage from the rectifier voltage detector, and configured to be switched on by the input driving voltage; a second transistor in which a source is connected to a ground voltage, a drain is connected to a second capacitor, and a gate receives the driving voltage from the rectifier voltage detector, and configured to be switched on by the input driving voltage; a first capacitor formed between a second short range communication antenna node and the first transistor, and configured to allow a resonance frequency of the short range communication resonance circuit to be shifted by a current path formed by the first transistor being switched on; and a second capacitor formed between a first short range communication antenna node and the second transistor, and configured to allow the resonance frequency of the short range communication resonance circuit to be shifted by the second transistor being switched on. In this case, a value of the first capacitor and a value of the second capacitor may be set such that a resonance frequency for short range wireless communication is lower than a resonance frequency for power transmission and reception.

The protection unit according to another embodiment may include: a first transistor in which a source is connected to a ground voltage, a drain is connected to a first resistor, and a gate receives a driving voltage from the rectifier voltage detector, and configured to be switched on by the input driving voltage; a second transistor in which a source is connected to the ground voltage, a drain is connected to a second resistor, and a gate receives the driving voltage from the rectifier voltage detector, and configured to be switched on by the input driving voltage; the first resistor formed between a second short range communication antenna node and the first transistor, and configured to allow a resonance frequency of the short range communication resonance circuit to be shifted by the first transistor being switched on; and the second resistor formed between a first short range communication antenna node and the second transistor, and configured to allow the resonance frequency of the short range communication resonance circuit to be shifted by the second transistor being switched on.

The protection unit according to another embodiment may include: a first transistor in which a source is connected to a ground voltage, a drain is connected to a first inductor, and a gate receives a driving voltage from the rectifier voltage detector, and configured to be switched on by the input driving voltage; a second transistor in which a source is connected to the ground voltage, a drain is connected to a second inductor, and a gate receives the driving voltage from the rectifier voltage detector, and configured to be switched on by the input driving voltage; the first inductor formed between a second short range communication antenna node and the first transistor, and configured to allow a resonance frequency of the short range communication resonance circuit to be shifted by the first transistor being switched on; and the second inductor formed between a first short range communication antenna node and the second transistor, and configured to allow the resonance frequency of the short range communication resonance circuit to be shifted by the second transistor being switched on. In this case, inductance values of the first inductor and the second inductor may be set to be larger than an inductance value of a short range communication antenna such that a resonance frequency for short range wireless communication is lower than a resonance frequency for a power transmission and reception.

Another aspect of the present invention provides a portable terminal including: a power receiving unit antenna; a short range communication antenna; a power receiving unit configured to receive a wireless power signal from a power transmitting unit through magnetic resonance of the power receiving unit antenna; a short range communication module configured to perform wireless communication using a magnetic field of the short range communication antenna; and a short range communication module protecting circuit configured to protect the short range communication module by determining whether the power receiving unit is in a state of receiving a power signal from the power transmitting unit for wireless charging, and blocking a power signal transmitted to the short range communication module when it is determined that the power receiving unit is in the state of receiving a power signal.

### Advantageous Effects

As should be apparent from the above, a short range communication module performing short range wireless communication can be protected from a power transmitting unit (hereinafter, referred to as a PTU) configured to supply a power signal to a power receiving unit (hereinafter, referred to as a PRU) for wireless charging.

A power signal is blocked from being supplied to a short range communication module for wireless charging to protect the short range communication module so that, when a PTU supplies a power signal, excessive power is prevented from being unintentionally supplied to the short range communication module which is configured to transmit and receive little power, and thus preventing breakage of the short range communication module.

### DESCRIPTION OF DRAWINGS

FIG. 1 is a circuit diagram illustrating a state in which an Alliance for Wireless Power (A4WP) power transmitting unit (PTU) supplies a power signal to an A4WP power receiving unit (PRU) when an A4WP antenna and a near field communication (NFC) antenna are located on the A4WP PTU,

FIG. 2 is a circuit diagram for measuring power received by the NFC antenna,

FIG. 3 is a waveform diagram illustrating a result of measuring a voltage and current of an NFC antenna when power is measured as shown in FIG. 2,

FIG. 4 is a reference diagram illustrating an image of a credit card equipped with an NFC chip and a mobile phone equipped with an A4WP PRU, which are placed on an A4WP PTU and captured by a thermal imaging camera,

FIG. 5 is circuit diagram of an NFC module protecting circuit according to a first embodiment of the present invention,

FIG. 6 is circuit diagram of an NFC module protecting circuit according to a second embodiment of the present invention,

FIG. 7 is circuit diagram of an NFC module protecting circuit according to a third embodiment of the present invention, and

FIG. 8 is circuit diagram of an NFC module protecting circuit according to a fourth embodiment of the present invention.

### MODES OF THE INVENTION

Hereinafter, embodiments of the present invention will be described in detail with reference to the accompanying drawings. In the description of the present invention, detailed descriptions of related known functions or constructions will be omitted to avoid obscuring the subject matter of the present invention. In addition, terms which are used below are defined in consideration of functions in the present invention, and may vary with an intention of a user and an operator or a custom. Accordingly, the definition of the terms should be determined on the basis of the overall content of the specification.

The present invention relates to a technology for protecting a short range communication module performing a short range wireless communication from a power transmitting unit (hereinafter, referred to as a PTU) configured to transmit a power signal to a power receiving unit (hereinafter, referred to as a PRU) for wireless charging. When power is supplied from a PTU for wireless charging, excessive power may be unintentionally supplied to a short range communication module configured to transmit and receive little power, and thus the short range communication module may be broken. Accordingly, by blocking supply of a wireless charging signal to the short range communication module, the short range communication module is protected.

The short range communication module according to an embodiment may include all types of communication modules capable of transmitting and receiving a wireless signal using a magnetic field, for example, a near field communication (hereinafter, referred to as NFC) module or a radio frequency identification (hereinafter, referred to as RFID) module. The short range communication module may perform short range wireless communication in a frequency band of several to several tens of MHz, and, for example, the short range communication module may transmit a wireless signal in a frequency band of 13.56 MHz.

The PTU and PRU according to an embodiment use an Alliance for Wireless Power (A4WP) scheme. According to the A4WP scheme, an A4WP PTU supplies a power signal to an A4WP PRU through magnetic resonance in a frequency band of 6.78 MHz. However, the wireless charging scheme according to the present invention is not limited to the A4WP. When wireless charging is performed in a frequency band different from a frequency band of a short range wireless communication not conforming to the A4WP scheme, for example, when wireless charging is performed at 4 MHz, an NFC module using a frequency band of 13.56 MHz or other short range communication modules using a frequency band close to that of the wireless charging may be protected.

The present invention may be applied to the protection of a short range communication module from a wireless charging system for transmitting and receiving a wireless power signal when a frequency band of the wireless charging system is relatively close to a frequency band of the short range communication module. For example, the present invention is applied to the protection of an NFC module using a frequency band of 13.56 MHz from an A4WP wireless charging system using a frequency band of 6.78 MHz.

Hereinafter, embodiments for protecting an NFC module will be described with reference to the following drawings while limiting the short range communication module to an NFC module, limiting the power transmitting unit to an A4WP PTU, and limiting the power receiving unit to an A4WP PRU to aid in the understanding of the present invention. However, the present invention is not limited thereto.

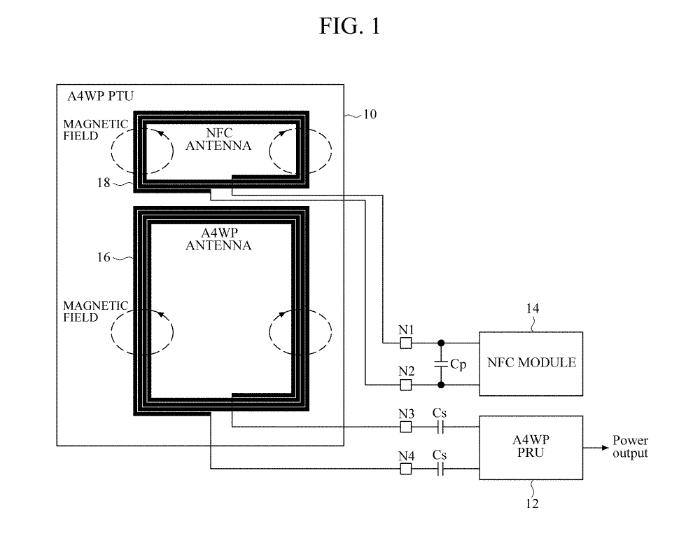

FIG. 1 is a circuit diagram illustrating a state in which an A4WP PTU supplies a power signal to an A4WP PRU when an A4WP antenna and an NFC antenna are located on the A4WP PTU.

Referring to FIG. 1, an A4WP PTU 10 supplies a power signal for wireless charging to an A4WP PRU 12 at a resonance frequency of 6.78 MHz. An A4WP antenna 16 and an NFC antenna 18 may be located on the A4WP PTU 10. When the A4WP PRU 12 is mounted on a portable terminal, such as a mobile phone, the A4WP antenna 16 is usually located on a rear surface of the portable terminal because a display is located on a front surface of the portable terminal, and the NFC antenna 18 is also usually located on the rear surface of the portable terminal. Accordingly, even when short range wireless communication using the NFC antenna 18 is not performed, the NFC antenna 18 is exposed to a magnetic field supplied by the A4WP PTU 10 during wireless charging, and thus a magnetic field is generated. Accordingly, a considerable amount of power signals may be received by the NFC antenna 18.

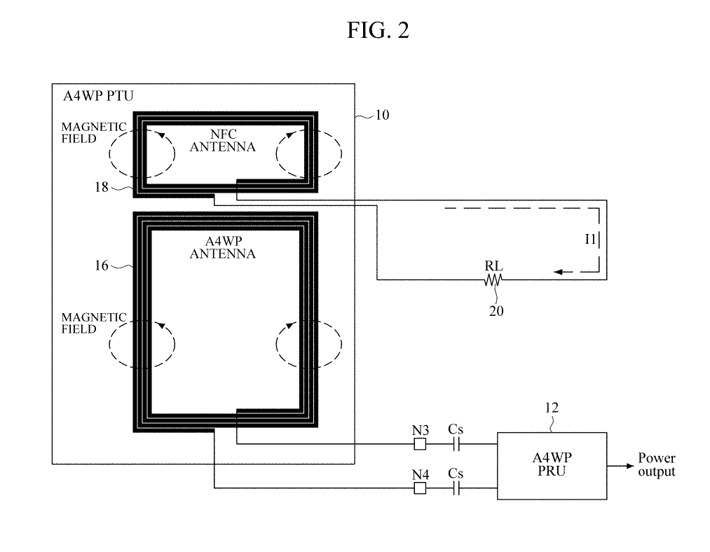

FIG. 2 is a circuit diagram for measuring power received by the NFC antenna.

Referring to FIG. 2, in order to measure received power of the NFC antenna 18, the NFC antenna 18 with a 10Ω resistor RL 20 is placed on the A4WP PTU 10. In this case, the A4WP PRU 12 is in a state of receiving about 5 W of power from the A4WP PTU 10.

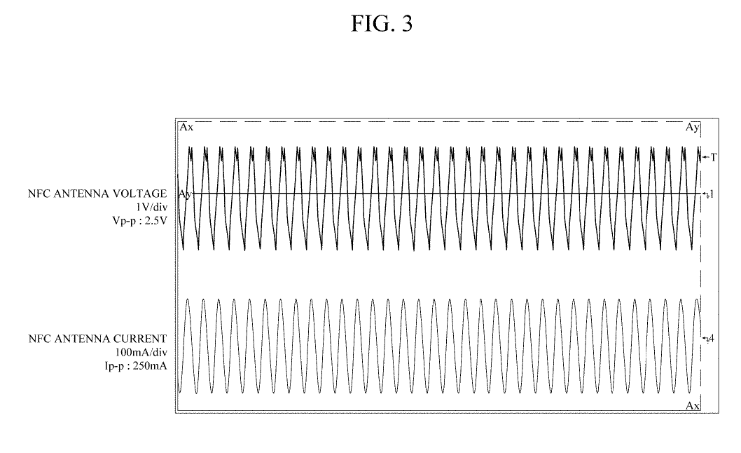

FIG. 3 is a waveform diagram illustrating a result of measuring a voltage and current of the NFC antenna when power is measured as shown in FIG. 2.

Referring to FIGS. 2 and 3, the NFC antenna 18 receives a voltage with a peak of about 2.5V and a current with a peak of 250 mA. The voltage and current of the NFC antenna 18 are determined by a function affected by a distance and position of the NFC antenna 18 with respect to the A4WP PTU 10, but the voltage and current of the NFC antenna 18 placed in the middle of the A4WP PTU 10 without being separated upward therefrom are measured as shown in FIG. 3. The A4WP PTU 10 having a maximum output power of about 15 W is used, but transmission power of the A4WP PTU 10 is about 10 W under experimental conditions.

It can be seen from the experiment results that the NFC antenna 18 received 0.3 W of power. Such a level of power is not great for the A4WP PRU 12, but is great enough to cause a problem in an NFC module 14.

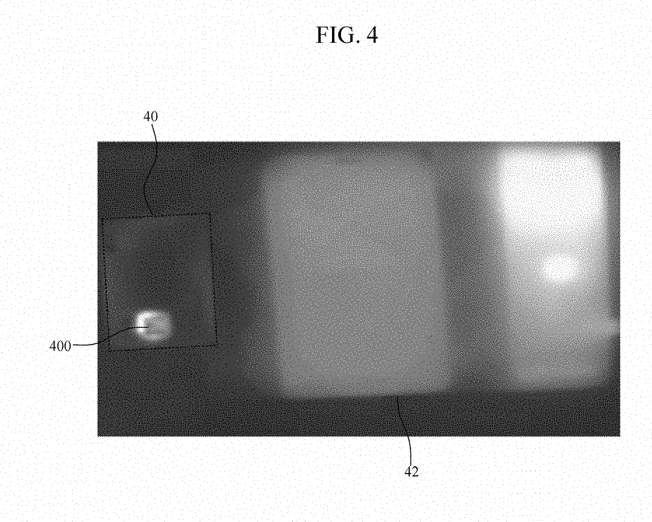

FIG. 4 is a reference diagram illustrating an image of a credit card equipped with an NFC chip and a mobile phone equipped with an A4WP PRU, which are placed on an A4WP PTU and captured by a thermal imaging camera.

Referring to FIG. 4, when a credit card 40 equipped with an NFC chip 400 and a mobile phone 42 equipped with an A4WP PRU are placed on an A4WP PTU, it can be seen that the NFC chip 400 of the credit card 40 is overheated by receiving a power signal. When the credit card 40 is left in this state for a predetermined period of time, for example, 10 minutes, the credit card 40 is broken.

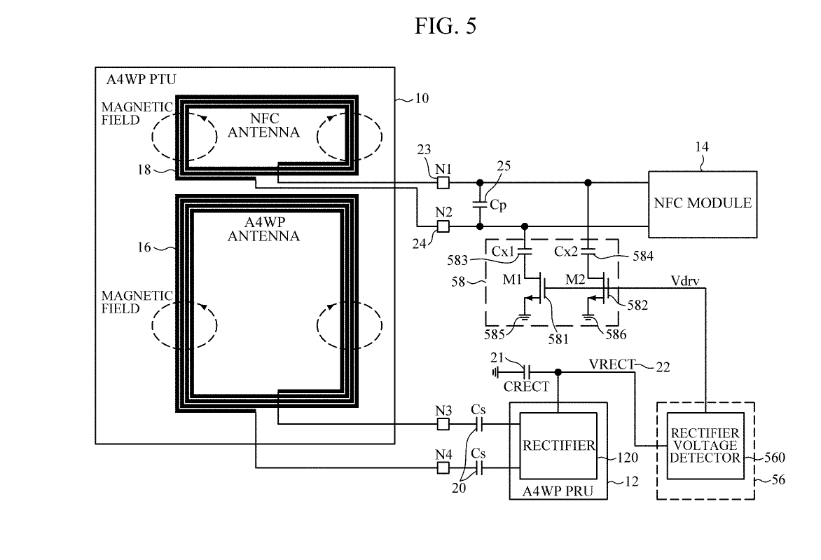

FIG. 5 is circuit diagram of an NFC module protecting circuit according to a first embodiment of the present invention.

Referring to FIG. 5, the NFC module protecting circuit includes a determination unit 56 and a protection unit 58.

The determination unit 56 determines whether the A4WP PRU 12 is in a state of receiving a power signal from the A4WP PTU 10 for wireless charging. The protection unit 58 protects the NFC module 14 by blocking a power signal transmitted to the NFC module 14 when the determination unit 56 determines that the A4WP PRU 12 is in a state of receiving a power signal. The A4WP PTU 10 and the A4WP PRU 12 transmit and receive a wireless power signal at a resonance frequency of 6.78 MHz through magnetic resonance, and the NFC module 14 performs wireless communication using a magnetic field in an operating frequency of 13.58 MHz. Since the frequency bands are very close, the NFC antenna 18 is affected by a magnetic field generated by the A4WP PTU 10 while the A4WP PTU 10 supplies power, and thus a magnetic field is generated in the NFC antenna 18. In this case, the protection unit 58 blocks a power signal supplied to the NFC module 14 by the magnetic field generated by the NFC antenna 1 to protect the NFC module 14.

The determination unit 56 according to an embodiment includes a rectifier voltage detector 560. The rectifier voltage detector 560 detects a rectifier output voltage VRECT 22 of the A4WP PRU 12, and determines whether a magnitude of the detected rectifier output voltage VRECT 22 increases to operate the A4WP PRU 12. When the detected rectifier output voltage VRECT 22 increases to a voltage at which the A4WP PRU 12 is operable, the determination unit 56 sends the protection unit 58 a high-level control signal to control the protection unit 58. Referring to FIG. 5, the determination unit 56 may be separated from the A4WP PRU 12, but the determination unit 56 may be located inside the A4WP PRU 12 according to a configuration of the apparatus.

The protection unit 58 according to an embodiment allows a resonance frequency of an NFC resonance circuit to be shifted by the high-level control signal received from the determination unit 56, thereby reducing power signals transmitted from the A4WP PTU 10 to the NFC antenna 18 and blocking a power signal transmitted from the NFC antenna 18 to the NFC module 14.

According to an embodiment, the A4WP antenna 16, the NFC antenna 18, the A4WP PRU 12, the NFC module 14, and the protecting circuit are mounted on a portable terminal. The A4WP PRU 12 receives a wireless power signal from the A4WP PTU 10 through magnetic resonance of the A4WP antenna 16, and the NFC module 14 performs wireless communication through a magnetic field of the NFC antenna 18. The protecting circuit determines whether the A4WP PRU 12 is in the state of receiving a power signal from the A4WP PTU 10 for wireless charging. When it is determined that the A4WP PRU 12 is in a state of receiving power for wireless charging, a power signal transmitted from the A4WP PTU 10 to the NFC module 14 due to a magnetic field generated in the NFC antenna 18 is blocked, and thus the NFC module 14 is protected.

Hereinafter, a protection process of the NFC module 14 by the protecting circuit will be described in detail with reference to the circuit shown in FIG. 5.

The A4WP PRU 12 includes a rectifier 120 for rectifying a 6.78 MHz alternating current (AC) signal, which is received from a resonator composed of the A4WP antenna 16 and a capacitor Cs 20, into a direct current (DC) signal. The rectifier output voltage VRECT 22 rectified by the rectifier 120 is converted into a DC signal by a capacitor CRECT 21. When a stable power signal is supplied to the A4WP PRU 12 from the A4WP PTU 10, a value of the capacitor CRECT 21 increases so that the rectifier output voltage VRECT 22 rises to a voltage suitable for operating the A4WP PRU 12. Meanwhile, when the A4WP PRU 12 is located on an NFC PTU and is affected by the NFC PTU, power received from the NFC PTU is not as great as power received from the A4WP PTU 10, and thus the rectifier output voltage VRECT 22 does not sufficiently rise. Accordingly, the rectifier voltage detector 560 determines a voltage level of the rectifier output voltage VRECT 22 and determines whether the rectifier output voltage VRECT 22 is in a state of receiving power according to A4WP.

When the A4WP PRU 12 is in a state of receiving power from the A4WP PTU 10 for wireless charging, the rectifier voltage detector 560 allows a driving voltage Vdrv to have a high level and sends the driving voltage Vdrv to MOSFETS M1 581 and M2 582 of the protection unit 58 to switch the MOSFETS M1 581 and M2 582 on. Outputs of the switched-on MOSFETS M1 581 and M2 582 are connected to capacitors Cx1 583 and Cx2 584, and the capacitors Cx1 583 and Cx2 584 are connected to NFC antenna nodes N1 23 and N2 24. When the MOSFETS M1 581 and M2 582 are switched on, current paths to the capacitors Cx1 583 and Cx2 584 are formed, and thus a resonance frequency of an NFC resonator composed of the NFC antenna 18 and a capacitor 25 is shifted such that power signals received by the NFC module 14 are reduced and most of the current flows through the capacitors Cx1 583 and Cx2 584, and thus the NFC module 14 is protected. In this case, a resonance frequency fr of the NFC resonator is expressed by Equation 1

fr=1/2n\sqrt{Ln(Cx/2+Cp)} [Equation 1]

In Equation 1, Ln is an equivalent inductance of the NFC antenna 18, and it is assumed that Cx1=Cx2=Cx. In order to protect the NFC module 14, values of the capacitors Cx1 583 and Cx2 584 may be set to be large such that the resonance frequency fr of the NFC resonator is significantly lower than a resonance frequency of 6.78 MHz between the A4WP PTU 10 and the A4WP PRU 12 (fr<<6.78 MHz).

When the A4WP PRU 12 is not in the state of receiving a power signal from the A4WP PTU 10, the MOSFETS M1 581 and M2 582 are switched off, and thus the NFC resonance frequency is not affected by the capacitors Cx1 583 and Cx2 584.

Meanwhile, a circuit configuration of the protection unit 58 will be described below. The protection unit 58 includes the MOSFET M1 581, the MOSFET M2 582, the capacitor Cx1 583, and the capacitor Cx2 584, as shown in FIG. 5.

In the MOSFET M1 581, a source is connected to a ground voltage 585, a drain is connected to the capacitor Cx1 583, and a gate receives the driving voltage Vdrv from the rectifier voltage detector 560, and the MOSFET M1 581 is switched on by the input driving voltage Vdrv. Similarly, in the MOSFET M2 582, a source is connected to a ground voltage 586, a drain is connected to the capacitor Cx2 584, and a gate receives the driving voltage Vdrv from the rectifier voltage detector 560, and the MOSFET M2 582 is switched on by the input driving voltage Vdrv. The capacitor Cx1 583 is formed between the NFC antenna node N2 24 and the MOSFET M1 581, and has a current path formed by the MOSFET M1 581 being switched on such that a resonance frequency of the NFC resonance is shifted. Similarly, the capacitor Cx2 584 is formed between the NFC antenna node N1 23 and the MOSFET M2 582, and allows a resonance frequency of the NFC resonance to be shifted by the MOSFET M2 582 being switched on.

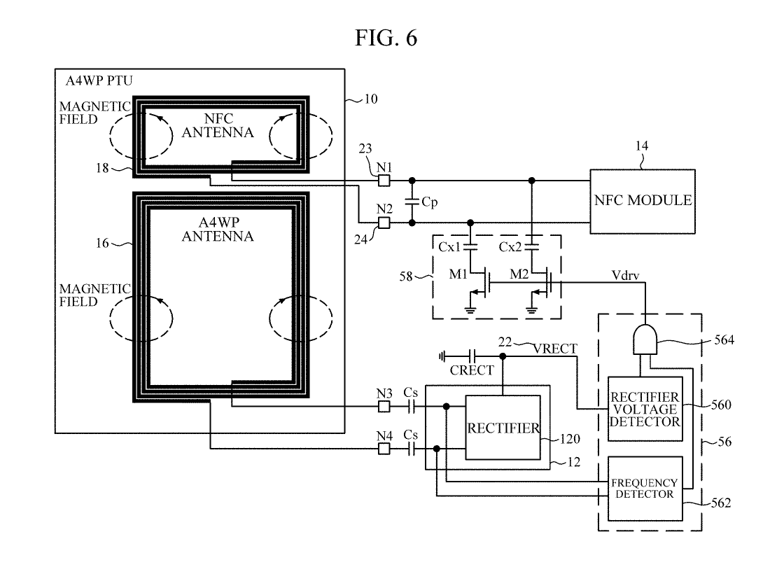

FIG. 6 is circuit diagram of an NFC module protecting circuit according to a second embodiment of the present invention.

Referring to FIG. 6, the determination unit 56 of the NFC module protecting circuit includes a frequency detector 562. The frequency detector 562 detects a resonance frequency of an A4WP resonator from a rectifier input signal input to the rectifier 120 of the A4WP PRU 12, and determines whether the detected resonance frequency is a resonance frequency for wireless charging. When it is determined that the detected resonance frequency is a resonance frequency for wireless charging, the frequency detector 562 sends the protection unit 58 a high-level control signal. For example, when the detected resonance frequency is about 6.78 MHz, which is a resonance frequency of the A4WP resonator, and is smaller than 13.56 MHz, which is a resonance frequency of the NFC resonator, it is determined that the detected resonance frequency is a resonance frequency for wireless charging, and thus the high-level control signal is sent to the protection unit 58.

The determination unit 56 of the NFC module protecting circuit according to an embodiment includes the rectifier voltage detector 560, the frequency detector 562, and an AND circuit 564. The rectifier voltage detector 560 detects the rectifier output voltage VRECT 22 of the A4WP PRU 12, and, when the detected rectifier output voltage VRECT 22 is a voltage having a magnitude at which the A4WP PRU 12 is operable, determines that a power signal is received and outputs a high-level control signal. The frequency detector 562 detects a resonance frequency of a A4WP resonator from a rectifier input signal input to the rectifier 120, and when the detected resonance frequency is a resonance frequency for wireless charging, determines that a power signal is received and outputs a high-level control signal. The AND circuit 564 receives the control signal of the rectifier voltage detector 560 and the control signal of the frequency detector 562, performs a logic product (AND) on the received control signals, and transmits the driving voltage Vdrv for controlling the protection unit 58 to the MOSFETS M1 581 and M2 582 of the protection unit 58. When the determination unit 56 includes the rectifier voltage detector 560, the frequency detector 562, and the AND circuit 564, the NFC module 14 may be more stably protected. The rectifier voltage detector 560 and the frequency detector 562 are provided separately from the A4WP PRU 12, as shown in FIG. 6, but may be located in the A4WP PRU 12 according to a design.

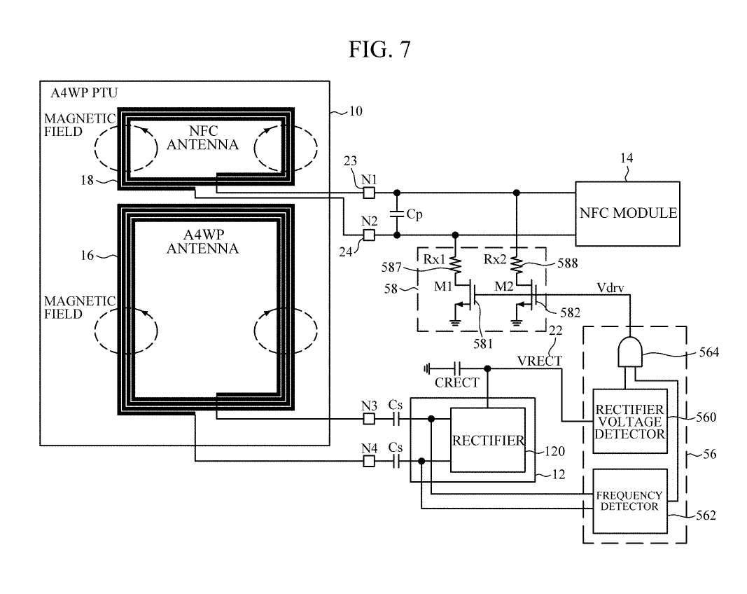

FIG. 7 is circuit diagram of an NFC module protecting circuit according to a third embodiment of the present invention.

Instead of using the capacitors Cx1 583 and Cx2 584 described with reference to FIGS. 5 and 6, the protection unit 58 of the NFC module protecting circuit according to an embodiment has outputs of the MOSPETS M1 581 and M2 582 directly connected to the NFC antenna nodes N1 23 and N2 24 to constrain transmission of a power signal received by the NFC antenna 18 and protect the NFC module 14. The protection unit 58 of the NFC module protecting circuit according another embodiment may have outputs of the MOSPET M1 581 and M2 582 connected to the NFC antenna nodes N1 23 and N2 24 via resistors Rx1 587 and Rx2 588, as shown in FIG. 7.

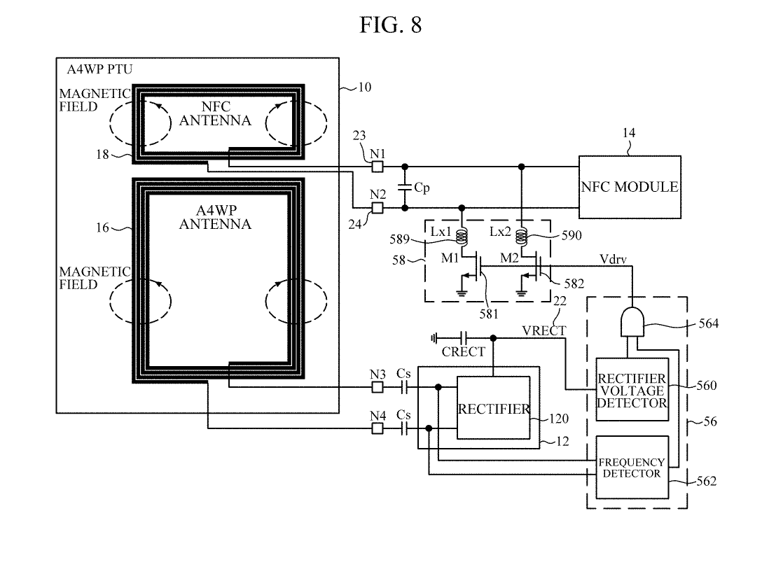

FIG. 8 is circuit diagram of an NFC module protecting circuit according to a fourth embodiment of the present invention.

Referring to FIG. 8, instead of using the capacitors Cx1 583 and Cx2 584 described with reference to FIGS. 5 and 6, the protection unit 58 of the NFC module protecting circuit has outputs of the MOSPET M1 581 and M2 582 connected to the NFC antenna nodes N1 23 and N2 24 via inductors Lx1 589 and Lx2 590 to constrain transmission of a power signal received by the NFC antenna 18 and protect the NFC module 14. When the inductors Lx1 589 and Lx2 590 are connected, a resonance frequency of a NFC resonator may be set to be sufficiently lower than a resonance frequency of a A4WP resonator, which is 6.78 MHz (fr<<6.78 MHz). To this end, an inductor having an inductance value sufficiently larger than an inductance value of the NFC resonator may be used for the A4WP resonator.

Although a method of protecting an NFC module from an A4WP charging system has been described with reference to FIGS. 5 to 8, the present invention is not limited to the A4WP charging method. Even when wireless charging is performed at a different frequency without conforming to the A4WP standard, for example, when wireless charging is performed at 4 MHZ, an NFC module using a frequency band of 13.56 MHz or other short range communication modules using a frequency range close to that of the wireless charging need to be protected, and, in this case, it should be obvious that the above-described method may be applied to the protection. Accordingly, the present invention provides a comprehensive method that may be used when a frequency of a short range communication module and a frequency of a wireless charging system providing a great power signal are relatively close to each other.

Although exemplary embodiments of the present invention have been described for illustrative purposes, those skilled in the art should appreciate that various modifications, additions, and substitutions are possible without departing from the scope and spirit of the invention. Therefore, exemplary embodiments of the present invention have been described for illustrative purposes and not for limiting purposes. Accordingly, the scope of the invention is not to be limited by the above embodiments but by the claims and the equivalents thereof.

1. A near field communication module protection apparatus, the apparatus comprising:
a determination unit configured to determine whether a power receiving unit is in a state of receiving a power signal from a power transmitting unit for wireless charging; and
a protection unit configured to protect a short range communication module by blocking a power signal transmitted to the short range communication module when the determination unit determines that the power receiving unit is in the state of receiving a power signal.

2. The apparatus of claim 1, wherein the power transmitting unit and the power receiving unit transmit and receive a wireless power signal in a first frequency band through magnetic resonance, and
the short range communication module performs wireless communication using a magnetic field in a second frequency band, and is affected by a magnetic field generated by magnetic resonance between the power transmitting unit and the power receiving unit.

3. The apparatus of claim 2, wherein the power transmitting unit and the power receiving unit transmit and receive a wireless power signal by using an Alliance for Wireless Power (A4WP) scheme.

4. The apparatus of claim 2, wherein the short range communication module is a near field communication (NFC) module or a radio frequency identification (RFID) module.

5. The apparatus of claim 2, wherein the first frequency band for wireless charging is 6.78 MHz, and the second frequency band for the short range communication module is 13.56 MHz.

6. The apparatus of claim 1, wherein the determination unit comprises a rectifier voltage detector configured to detect a rectifier output voltage of the power receiving unit, determine that the power receiving unit is in the state of receiving a power signal when the detected rectifier output voltage is a voltage having a magnitude at which the power receiving unit is operable, and send the protection unit a high-level driving voltage to control the protection unit.

7. The apparatus of claim 1, wherein the determination unit comprises a frequency detector configured to detect a resonance frequency from a rectifier input signal of the power receiving unit, determine that the power receiving unit is in the state of receiving a power signal when the detected resonance frequency is a resonance frequency for wireless charging, and send the protection unit a high-level driving voltage to control the protection unit.

8. The apparatus of claim 1, wherein the determination unit comprises:
a rectifier voltage detector configured to detect a rectifier output voltage of the power receiving unit, determine that the power receiving unit is in the state of receiving a power signal when the detected rectifier output voltage is a voltage having a magnitude at which the power receiving unit is operable, and output a high-level control signal;
a frequency detector configured to detect a resonance frequency from a rectifier input signal of the power receiving unit, determine that the power receiving unit is in the state of receiving a power signal when the detected resonance frequency is a resonance frequency for wireless charging, and output a high-level control signal; and
an AND circuit configured to receive the control signal of the rectifier voltage detector and the control signal of the frequency detector, perform a logic product on the received control signals, and send the protection unit a driving voltage for controlling the protection unit.

9. The apparatus of claim 1, wherein the protection unit allows a resonance frequency of a short range communication resonance circuit to be shifted to reduce an amount of power signals transmitted from the power transmitting unit to a short range communication antenna, and block a power signal transmitted from the short range communication antenna to the short range communication module.

10. The apparatus of claim 1, wherein the protection unit comprises:
a first transistor in which a source is connected to a ground voltage, a drain is connected to a first capacitor, and a gate receives a driving voltage from the rectifier voltage detector, and configured to be switched on by the input driving voltage;
a second transistor in which a source is connected to the ground voltage, a drain is connected to a second capacitor, and a gate receives the driving voltage from the rectifier voltage detector, and configured to be switched on by the input driving voltage;
the first capacitor formed between a second short range communication antenna node and the first transistor, and configured to allow a resonance frequency of the short range communication resonance circuit to be shifted by a current path formed by the first transistor being switched on; and
the second capacitor formed between a first short range communication antenna node and the second transistor, and configured to allow the resonance frequency of the short range communication resonance circuit to be shifted by the second transistor being switched on.

11. The apparatus of claim 10, wherein a value of the first capacitor and a value of the second capacitor are set such that a resonance frequency for short range wireless communication is lower than a resonance frequency for power transmission and reception.

12. The apparatus of claim 1, wherein the protection unit comprises:
a first transistor in which a source is connected to a ground voltage, a drain is connected to a first resistor, and a gate receives a driving voltage from a rectifier voltage detector, and configured to be switched on by the input driving voltage;
a second transistor in which a source is connected to the ground voltage, a drain is connected to a second resistor, and a gate receives the driving voltage from the rectifier voltage detector, and configured to be switched on by the input driving voltage;
a first resistor formed between a second short range communication antenna node and the first transistor, and configured to allow a resonance frequency of a short range communication resonance circuit to be shifted by the first transistor being switched on; and
a second resistor formed between a first short range communication antenna node and the second transistor, and configured to allow the resonance frequency of the short range communication resonance circuit to be shifted by the second transistor being switched on.

13. The apparatus of claim 1, wherein the protection unit comprises:
a first transistor in which a source is connected to a ground voltage, a drain is connected to a first inductor, and a gate receives a driving voltage from a rectifier voltage detector, and configured to be switched on by the input driving voltage;
a second transistor in which a source is connected to the ground voltage, a drain is connected to a second inductor, and a gate receives the driving voltage from the rectifier voltage detector, and configured to be switched on by the input driving voltage;
the first inductor formed between a second short range communication antenna node and the first transistor, and configured to allow a resonance frequency of a short range communication resonance circuit to be shifted by the first transistor being switched on; and
the second inductor formed between a first short range communication antenna node and the second transistor, and configured to allow the resonance frequency of the short range communication resonance circuit to be shifted by the second transistor being switched on.

14. The apparatus of claim 13, wherein inductance values of the first inductor and the second inductor are set to be larger than an inductance value of a short range communication antenna such that a resonance frequency for short range wireless communication is lower than a resonance frequency for a power transmission and reception.

15. A portable terminal comprising:
a power receiving unit antenna;
a short range communication antenna;
a power receiving unit configured to receive a wireless power signal from a power transmitting unit through magnetic resonance of the power receiving unit antenna;
a short range communication module configured to perform wireless communication using a magnetic field of the short range communication antenna; and
a short range communication module protecting circuit configured to protect the short range communication module by determining whether the power receiving unit is in a state of receiving a power signal from the power transmitting unit for wireless charging, and blocking a power signal transmitted to the short range communication module when it is determined that the power receiving unit is in the state of receiving a power signal.
